(19) United States
(12) Patent Application Publication
(10) Pub. No.: US 2018/0262055 A1
(43) Pub. Date: Sep. 13, 2018

(54) WIRELESS POWER CONVERSION SYSTEM

(71) Applicant: POGOTEC, INC., ROANOKE, VA (US)

(72) Inventors: JOSHUA A. SCHOENBART, BROOKLINE, MA (US); WILLIAM KOKONASKI, BELFAIR, WA (US); AMITAVA GUPTA, ROANOKE, VA (US); RONALD D. BLUM, ROANOKE, VA (US)

(73) Assignee: POGOTEC, INC., ROANOKE, VA (US)

(21) Appl. No.: 15/917,413

(22) Filed: Mar. 9, 2018

Related U.S. Application Data
(60) Provisional application No. 62/469,314, filed on Mar. 9, 2017.

(51) Int. Cl. H02J 50/12; H01F 38/14; H01F 27/24; H01F 27/08; H02J 50/80; H02J 7/02

(52) U.S. Cl. CPC H02J 50/12; H01F 38/14; H01F 27/24; H02J 50/40; H02J 50/80; H02J 7/025; H01F 27/08

(57) ABSTRACT

A wireless power receiver, a system including the receiver, and a method for using the receiver are discussed. The wireless power system according in some examples may include a wireless power receiver including a coil for receipt of wireless power from a distance separated wireless power transmitter and a port, The system may include an electronic device including a port for coupling to the port of the wireless power receiver for receipt of electric power to at least partially power the electronic device. The wireless power receiver may be removably coupleable to the port of the electronic device and may at least partially power the electronic device by providing power received by the wireless power receiver through the port.

### CROSS-REFERENCE TO RELATED APPLICATION(S)

This application claims the benefit under 35 U.S.C. § 119 of the earlier filing date of U.S. Provisional Application Ser. No. 62/469,314 filed Mar. 9, 2017, the entire contents of which are hereby incorporated by reference in their entirety for any purpose.

### TECHNICAL FIELD

Examples described herein relate to wireless power systems and methods suitable for charging electronic devices, including wearable electronic devices.

### BACKGROUND

Wireless power transfer systems come in many different formats, by way of example only; Qi, Power Matters Alliance (PMA), Alliance for Wireless Power (A for WP, or Rezence), AirFuel Alliance. In each case, a coil found in the transmitting device may be wirelessly coupled to a coil in the receiving device. When the coils are highly impedance matched and the Q value is greater than 100, such a wireless power system is said to be highly resonant or tightly coupled. When such a system is slightly impedance matched and whereby the Q value is 100 or less, the system is said to be slightly resonant or loosely coupled. While wireless power transfer systems may be used for wireless charging of a distance separated wirelessly coupled electronic device, these systems have not gained commercial traction.

### BRIEF DESCRIPTION OF THE DRAWINGS

FIG. 1 is a block diagram of a system for wirelessly powering one or more electronic devices according to examples described herein.

FIG. 2 is a receiving coil for a wireless power receiver and a transmitting coil for a wireless power transmitter according to examples described herein.

FIG. 3 is a wireless power system arranged in accordance with examples described herein.

FIG. 4 is a method for operating a wireless power receiver arranged in accordance with examples described herein.

FIG. 5 is a method for operating a wireless power receiver arranged in accordance with examples described herein.

FIG. 6 is a circuit diagram of an example full wave rectifier circuit.

### DETAILED DESCRIPTION

Certain details are set forth herein to provide an understanding of described embodiments of technology. However, other examples may be practiced without various of these particular details. In some instances, well-known circuits, control signals, timing protocols, electronic device components, and/or software operations have not been shown in detail in order to avoid unnecessarily obscuring the described embodiments. Other embodiments may be utilized, and other changes may be made, without departing from the spirit or scope of the subject matter presented here.

The lack of commercial viability of wireless charging systems may not be due to the convenience offered the consumer or the positive benefit provided. The lack of commercial viability may be due to the complexity of creating a wireless power ecosystem whereby the coils of the receivers of electronic devices and the coils of the transmitters of the electronic devices all are compatible (e.g., tuned and wirelessly coupled). However, given the number of different electronic devices and the number of different competing companies around the world that sell and market electronic devices, such an ecosystem may be difficult and/or almost impossible to establish.

There is a need to more easily allow for compatibility between existing electronic devices and remote wireless power transmitters. It would be desirable to allow a consumer the ability to convert most any electronic device and transform it so to become wireless power compatible.

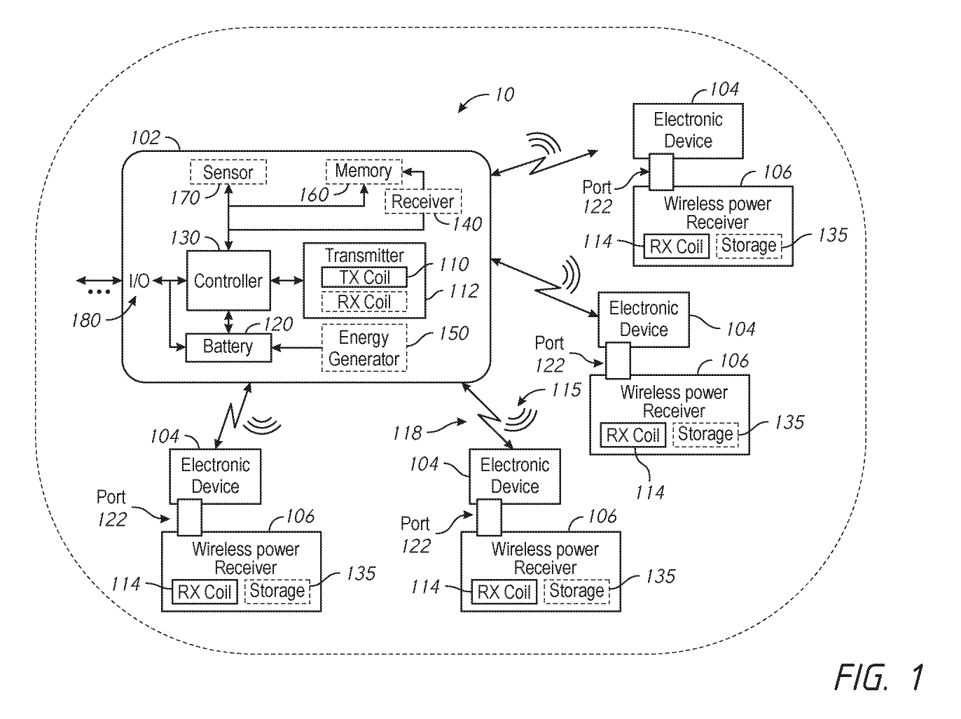

FIG. 1 is a block diagram of a system for wirelessly powering one or more electronic devices according to one embodiment.

The system 10 includes a wireless power transmitting device 102 and one or more wireless power receivers 106 removeably coupleable to one or more respective electronic devices 104 over a port 122. The wireless power transmitting device 102 may wirelessly power the one or more electronic devices 104 via the one or more wireless power receivers 106, which may be separated from the wireless power transmitting device 102 by a distance. The wireless power transmitting device 102 may provide power wirelessly to an electronic device 104 via a wireless power receiver 106 while the wireless power receiver 106 remains within a threshold distance (e.g., a charging range or charging zone 182) of the wireless power transmitting device 102. The wireless power transmitting device 102 may selectively transmit power wirelessly to any number of electronic devices 104 via respective wireless power receivers 106 (e.g., 1, 2, 3, 4, 5, 6, 7, 8, 9, or 10 although a greater number than 10 devices may be charged in some examples) within a proximity (e.g., within the charging range) of the wireless power transmitting device 102. Although electronic devices 104 may typically be charged via the wireless power receiver 106 (e.g., coupled to the wireless power transmitting device 102 for charging) while being distance separated from the wireless power transmitting device 102, it is envisioned and within the scope of this disclosure that the wireless power transmitting device 102 may operate to provide power wirelessly to the wireless power receivers 106 when the wireless power receivers 106 are adjacent to or in contact with the wireless power transmitting device 102.

The wireless power transmitting device 102 includes a transmitter 110, a battery 120, and a controller 130. The transmitter 110 includes at least one transmitting coil 112 (interchangeably referred to as Tx coil). The transmitting coil 112 may include a magnetic core with conductive windings. The windings may include copper wire (also referred to as copper windings). In some examples, the copper wire may be monolithic copper wire (e.g., single-strand wire). In some examples, the copper wire may be multi-strand copper wire (e.g., Litz wire), which may reduce resistivity due to skin effect in some examples, which may allow for higher transmit power because resistive losses may be lower. In some examples, the magnetic core may be a ferrite core (interchangeably referred to as ferrite rod). The ferrite core may comprise a medium permeability ferrite, for example 78 material supplied by Fair-Rite Corporation. in some examples, the ferrite core may comprise a high permeability material, such as Vitroperm 500F supplied by Vacuumschmelze in Germany. Ferrite cores comprising other ferrite materials may be used. In sonic examples, the ferrite may have a medium permeability of micro-i (μ) of about 2300. In some examples, the ferrite may have permeability of micro-i (μ) ranging from about 200 to about 5000, in some examples, different magnetic material may be used for the magnetic core. Generally, transmitting coils described herein may utilize magnetic cores which may in some examples shape the field provided by the transmitting coil, as the field lines preferentially go through the magnetic core, in this manner, partially guided flux may be used where a portion of the flux is guided by the magnetic core.

The transmitting coil 112 may be inductively coupled to a receiving coil 114 (interchangeably referred to as Rx coil) in the wireless power receiver 106. In this manner, power may be transmitted from the transmitting coil (e.g., TX coil 112) to the receiving coil (e.g., RX coil 114) (e.g. through inductive coupling). In some examples, the transmitter 110 may be additionally be used as a receiver and may thus be interchangeably referred to as transmitter/receiver, :For example, the transmitting coil of the transmitter/receiver may additionally be used as a receiving coil. In some examples, the transmitter/receiver may additionally include a receiving coil. In yet further examples, the wireless power transmitting device 102 may include a separate receiver 140 including a receiving coil. The transmitter/receiver or separate receiver of the wireless power transmitting device 102 may wirelessly receive power 116 and/or data 118. In some examples, the transmitter 110 may include a single transmitting coil 112, The transmitting coil 112 may be placed in an optimal location and/or orientation to provide an optimum charging zone 182. In some examples, the transmitting coil 112 may be placed in a location within the wireless power transmitting device 102 selected to provide a large number of charging opportunities during a typical use of the device. For example, the transmitting coil 112 may be placed near a side of the wireless power transmitting device 102 which most frequently comes in proximity to the wireless power receiving device 106.

in some examples, the transmitter 110 may include a plurality of transmitting coils 112. The transmitting coils 112 may be arranged in virtually any pattern. For example, the wireless power transmitting device 102 may include a pair of coils which are angled to one another, In some examples, the coils may be arranged at angles smaller than 90 degrees, for example ranging between 15-75 degrees. In some examples, the coils may be arranged at 45 degrees relative to one another. Other combinations and arrangements may be used.

In some examples, the transmitting coils may be arranged to provide a nearly omnidirectional charging zone 182 (also referred to as charging sphere or hotspot). The charging zone 182 of the wireless power transmitting device 102 may be defined by a three dimensional space around the wireless power transmitting device 102 which extends a threshold distance from the wireless power transmitting device 102 in all three directions (e.g., the x, y, and z directions). Although a three dimensions (3D) space corresponding to a charging range of the wireless power transmitting device 102 may be referred to herein as a sphere, it will be understood that the three dimensions (3D) space corresponding to a charging range need not be strictly spherical in shape. In some examples, the charging sphere may be an ellipsoid or a different shape.

Efficiency of wireless power transfer within the charging zone 182 may be variable, for example, depending on a particular combination of transmitting and receiving coils and/or a particular arrangement of the coils or relative arrangements of the coils in the wireless power transmitting device 102 and wireless power receiving device 106. The one or more transmitting coils 112 may be arranged within a housing of the wireless power transmitting device 102 in a manner which improves the omnidirectionality of the charging zone 182 and/or improves the efficiency of power transmission within the zone 106. In some examples, one or more transmitting coils 112 may be arranged within the housing in a manner which increases the opportunities for charging during typical use of the wireless power transmitting device 102. For example, the transmitting coil(s) may extend, at least partially, along one or more sides of the wireless power transmitting device 102 which are most brought near the wireless power receiving device 106. In some examples, the wireless power transmitting device 102 may be placed on a surface (e.g., a table or desk) during typical use and electronic devices including respective wireless power receiving devices may be placed around the wireless power transmitting device 102. In such examples, the transmitting coil(s) may be arranged along a perimeter of the wireless power transmitting device 102 housing.

In some examples, the wireless power transmitting device 102 may be attached to a mobile phone via an attachment mechanism such as adhesive attachment, an elastic attachment, a spring clamp, suction cup(s), mechanical pressure, or others. In some examples, the wireless power transmitting device 102 may be enclosed or embedded in an enclosure (also referred to as housing), which may have a generally planar shape (e.g., a rectangular plate). An attachment mechanism may be coupled to the housing such that the wireless power transmitting device 102 may be removably attached to a mobile phone, a table, or other communication device. In an example, the attachment mechanism may be a biasing member, such as a clip, which is configured to bias the mobile phone towards the wireless power transmitting device 102 in the form of by way of example only, a rectangular plate. For example, a clip may be provided proximate a side of the wireless power transmitting device 102 and the wireless power transmitting device 102 may be attached to (e.g., clipped to) the mobile phone via the clip in a manner similar to attaching paper or a notebook/notepad to a clip board. In some examples, the wireless power transmitting device 102 may be adhesively or elastically attached to the communication device and/or to a case of the communication device.

In further examples, the wireless power transmitting device 102 may be separate from the communication device. In yet further examples, the wireless power transmitting device 102 may be incorporated into (e.g., integrated into) the communication device. For example, the transmitter 108 may be integrated with other components of a typical mobile phone. The controller 130 may be a separate IC in the mobile phone or its functionality may be incorporated into the processor and/or other circuitry of the mobile phone. Typical mobile phones include a rechargeable battery which may also function as the battery 120 of the wireless power transmitting device 102. In this manner, a mobile phone may be configured to provide power wirelessly to electronic devices (e.g., such as separated electronic wearable devices) via the wireless power receivers.

As previously noted, the wireless power transmitting device 102 may include a battery 120 or other energy storage device. The battery 120 may be a rechargeable battery, such as a Nickel-Metal Hydride (NiMH), a Lithium ion (Li-ion), or a Lithium ion polymer (Li-ion polymer) battery. The battery 120 may he coupled to other components to receive power. For example, the battery 120 may be coupled to an energy generator 150. The energy generator 150 may include an energy harvesting device which may provide harvested energy to the battery for storage and use in charging the electronic device(s) via the respective wireless power receiving device(s). Energy harvesting devices may include, but not be limited to, kinetic-energy harvesting devices, solar cells, thermoelectric generators, or radio-frequency harvesting devices. In some examples, the battery 120 may be coupled to an input/output connector 180 such as a universal serial bus (USB) port. It will he understood that the term USB port herein includes any type of USB interface currently known or later developed, for example mini and micro USB type interfaces. Other types of connectors, currently known or later developed, may additionally or alternatively be used. The I/O connector 180 (e.g., USB port) may be used to connect the wireless power transmitting device 102 to an external device, for example an external power source or a computing device (e.g., a personal computer, laptop, tablet, or a mobile phone).

The transmitter 110 may be operatively coupled to the battery 120 to selectively receive power from the battery and wirelessly transmit the power to the electronic device 104 via the wireless power receiving device 106. As described herein, in some examples, the transmitter may combine the functionality of transmitter and receiver. In such examples, the transmitter may also be configured to wirelessly receive power from an external power source. It will be understood that during transmission, power may be wirelessly broadcast by the transmitter and may be received by any receiving devices within proximity (e.g., within the broadcast distance of the transmitter),

The transmitter 110 may be weakly-coupled to a receiver in the wireless power receiver 106 in some examples. There may not be a tight coupling between the transmitter 110 and the receiver in the wireless power receiver 106. Highly resonant coupling may be considered tight coupling. The weak (or loose) coupling may allow for power transmission over a distance. So, for example, the transmitter 110 may be distance separated from the receiver. The distance may be greater than 1 mm in some examples, greater than 10 mm in some examples, greater than 100 mm in some examples, and greater than 1000 mm in some examples. Other distances may be used in other examples, and power may be transferred over these distances.

The transmitter 110 and the receiver 140 in the wireless power transmitting device 102 may include impedance matching circuits each having an inductance, capacitance, and resistance at a particular radiofrequency. The dimension of the antenna in the transmitter or the receiver may be substantially smaller than the distance of wireless energy transmission such that of wireless transmission of power may be considered to be far field transmission. Resonant amplification of transfer efficiency is generally modest in far field transmissions, and for maximum amplification, the dimensions of the coil should be at least one tenth the wavelength of the radiofrequency being used to effect wireless charging. For example, transmission at an RF frequency of 1 GHZ may use a linear antenna of minimum length 3.0 cm. This may favor use of relatively high frequencies in wireless power transfer between the transmitter and the receiver in this configuration. An example range of the length (longest dimension) of the transmitting and the receiving antennas is between 10 mm and 1000 mm, another example range is between 100 mm and 500 mm. This range in antenna length will be effective for a wireless frequency range of 60-300 MHZ.

The transmitter 110 may generally provide a wireless power signal which may be provided at a body-safe frequency, e.g. less than 500 kHz in some examples, less than 300 kHz in some examples, less than 200 kHz in some examples, less than 125 kHz in some examples, less than 100 kHz in some examples, although other frequencies may be used. It may be desirable to utilize a frequency which is not regulated, or not heavily regulated. For example, a frequency less than 300 kHz in some examples.

Transmission/broadcasting of power may be selective in that a controller controls when power is being broadcast. The wireless power transmitting device may include a controller 130 coupled to the battery 120 and transmitter 110. The controller 130 may be configured to cause the transmitter 110 to selectively transmit power. A charger circuit may be connected to the battery 120 to protect the battery from overcharging. The charger circuit may monitor a level of charge in the battery 120 and turn off charging when it detects that the battery 120 is fully charged. The functionality of the charger circuit may, in some examples, be incorporated within the controller 130 or it may be a separated circuit (e.g., separate IC chip).

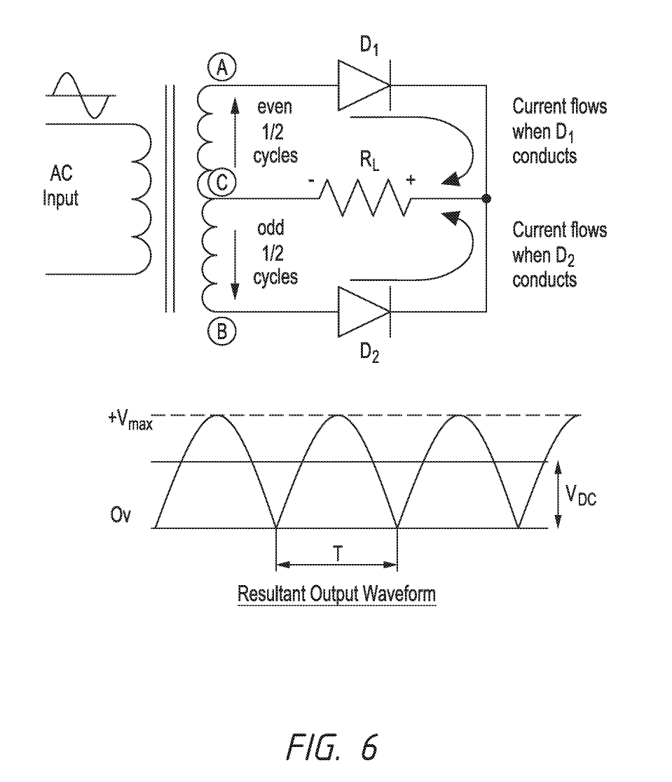

In some examples, the receiving circuit may include one or more temperature controllers, including as an example only, Peltier coolers in order to reduce and/or minimize change in electrical characteristics of the receiving circuit as the power transfer rate is increased, by increasing the power density of the transmitted RF field, as an example. This is because, electrical resistance, capacitance and inductance of electrical components utilized to construct the receiving circuit may change with temperature, thus causing a drift away from resonance coupling as temperature deviates from the design temperature of the device. In some examples, a rectifier may be included in and/or coupled to the receiver circuit. A rectifier may include a full wave rectifier circuit including two power diodes connected to a single load resistance. An example circuit diagram of a full wave rectifier circuit which may be used is shown in FIG. 6. A rectification efficiency of 97-98% is achievable by these and/or other mechanisms.

In some examples, the wireless power transmitting device 102 may include a memory 160. The memory 160 may be coupled to the transmitter 108 and/or any additional transmitters and/or receivers (e.g., receiver 140) for storage of data transmitted to and from the wireless power transmitting device 102. For example, the wireless power transmitting device 102 may communicate data wirelessly to and from electronic devices 104 via the wireless power receivers 106, e.g., receive images acquired with an electronic device in the form of a wearable camera, or transmit configuration data to the electronic devices. The wireless power transmitting device 102 may include one or more sensors 170, which may be operatively coupled to the controller.: sensor 170 may detect a status of the wireless power transmitting device such that the transmitter may provide power selectively and/or adjustably under control from controller 130.

In addition to circuitry adapted to perform the functions of providing power and data signals to the electronic devices 104, the wireless power receivers 106 may further include circuitry associated with wireless charging. The wireless power receivers 106 may include at least one receiving coil 114, which may be coupled to storage 135 for energy storage. The storage 135 may be implemented using a battery, a rechargeable power cell (e.g., power supply) onboard the wireless power receiver 106. Frequent charging in a manner that is non-invasive or minimally invasive to the user during typical use of the wireless power receiver may be achieved via wireless coupling between the receiving and transmitting coils in accordance with the examples herein.

The electronic device 104 may provide virtually any functionality. For example, one or more electronic devices described herein may be implemented using a camera, a wearable camera, an electronic watch, electronic band, fitness hand, and/or other such smart devices. In some examples, the electronic device may be a wearable electronic device, which may interchangeably he referred to herein as electronic wearable devices. The electronic device may have a sufficiently small form factor to make it easily portable by a user. The electronic device 104 may be attachable to clothing or an accessory worn by the user, for example eyewear. For example, the electronic device 104 may be attached to eyewear using a guide (e.g., track) incorporated in the eyewear.

In some examples the electronic device 104 itself may not include a wireless power receiver (e.g., a receiving coil), or may not include one which is compatible with the transmitter of the wireless power transmitting device 102. Accordingly, examples described herein may provide a wireless power receiver 106 which may be removeably coupled to a port (e.g., port 122) of the electronic device 104. The wireless power receiver may provide some or all of the power used during operation of the electronic device 104 through the port 122. The port 122 may be implemented, for example, using a USB port or other interface. In this manner, it may not be necessary in some examples for the electronic device 104 itself to include components for receipt of wireless power. By providing wireless power receivers, such as wireless power receiver 106, which may be removeably coupled to power electronic devices, consumers may more easily adapt electronic devices to receive wireless power. For example, the electronic device 104 may have insufficient power to operate without use of power received by the wireless power receiver 106. The electronic device 104 may be itself incapable of receiving wireless power without being coupled to the wireless power receiver 106 over the port 122.

The wireless power receiver 106 may include a receiving coil 114 and storage 135. During operation, the receiving coil 114 may receive wireless power from the wireless power transmitting device 102. Power received by the receiving coil 114 may be provided to the electronic device 104 over the port 122. The power may be provided over the port 122 as it is received and/or the power may be stored in storage 135 and provided over the port 122 at a later time (e.g., responsive to demand of the electronic device 104).

The wireless power receiver 106 may include additional circuitry for example, circuitry may be provided coupled to the receiver coil 114 for impedance matching and/or use in receiving wireless power. Circuitry may be coupled to the receiver coil 114 and/or the storage 135 for providing power signals in a format suitable for the port 122. For example, circuitry may be provided for providing power over a USB port.

During operation, the wireless power receiver 106 may be coupled to the electronic device 106 at the port 122, Note that the wireless power receiver 106 may be coupled and decoupled from the port 122 any number of times. In some examples, a single wireless power receiver 106 may be used with any of a number of electronic devices (e.g., the wireless power receiver may first be coupled to the port of a first electronic device, then decoupled form the port of the first electronic device and later coupled to the port of a second electronic device). The wireless power receiver 106 may generally be used with any electronic device having a compatible port to facilitate connection to the wireless power receiver 106.

In some examples, the wireless power transmitting device may additionally be used a. booster for RF energy—e.g. way of example only, examples of wireless power transmitting devices described herein may include components that may boost RF energy such as that of Bluetooth, ZigBee, or other signals coming from, e.g. a smart phone or mobile communication system that may be inserted into and/or positioned near wireless power transmitting devices described herein. For example, the wireless power transmitting device may include a transceiver circuit that may pick up the RF energy, by way of example only, one of a; WIFI, Bluetooth, ZigBee signal generated by the smart phone or mobile communication system and rebroadcast the signal at higher power levels to be, for example, picked up by a wearable electronic device. This rebroadcast can be implemented using, for example, a unidirectional antenna that predominately broadcast the energy in a direction away from the user's head when they are talking on the smart phone or mobile communication system. In some examples, a boost circuit in the wireless power transmitting device may increase power when wearable devices are detected by the wireless power transmitting device or by an application running on the smart phone or mobile communication system. In some examples controls could reside in the application running on the smart phone or mobile communication system. In addition to boosting power for energy transfer, data signals may also be amplified to improve data transfer between a wearable device and the smart phone or mobile communication system.

In some examples, the wireless power transmitting device may generate an RF signal with an RF generating circuit included the wireless power transmitting device. For example, the RF signal may be generated at a frequency consistent with a receiver in an energy harvesting circuit of a wearable device. Such a RF generating transmitter in the wireless power transmitting device maybe turned on, for example, by a signal from a communication system or other electronic device when, for example the communication system or other electronic device receives a message from a wearable device or other indicator that the wearable device may require additional energy that is not available from the environment to produce adequate charging current for a battery or capacitor in the wearable device.

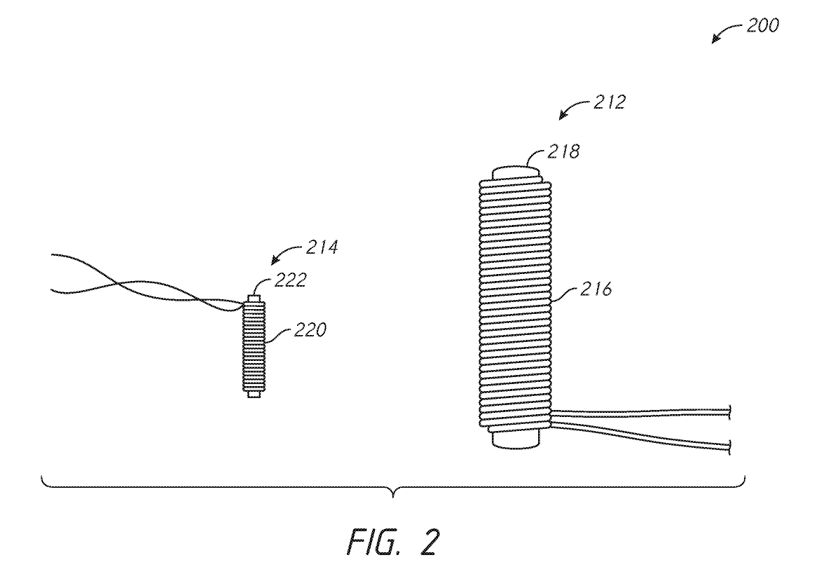

FIG. 2 is a receiving coil for a wireless power receiver and a transmitting coil for a. wireless power transmitter according to one embodiment.

The receiving coil (e.g., Rx coil 214) may be significantly smaller than the transmitting coil (e.g., Tx coil 212). In some examples, the transmitting coil may have a dimension (e.g., a length of the wire forming the Tx windings 214, a diameter of the wire forming the Tx windings 216, a diameter of the Tx coil 212, a number of Tx windings 216, a length of the Tx core 218, a diameter of the Tx core 218, a surface area of the Tx core 218) which is greater, for example twice or more, than a respective dimension of the Rx coil 214 (e.g., a length of the wire forming the Rx windings 220, a diameter of the Rx coil 214, a number of Rx windings 220, a length of the Rx coil 214, a surface area of the Rx coil 214). In some examples, a dimension of the Tx coil 212 may be two times or greater, five times or greater, 10 times or greater, 20 times or greater, or 50 times or greater than a respective dimension of the Rx coil 214. In some examples, a dimension of the Tx coil 212 may be up to 100 times a respective dimension of the Rx coil 214. For example, the receiving coil (e.g., Rx coil 214) may include conductive wire having wire diameter of about 0.2 mm, The wire may be a single strand wire. The Rx coil 214 in this example may have a diameter of about 2.4 mm and a length of about 13 mm, The Rx coil 214 may include a ferrite rod having a diameter of about 1.5 mm and a length of about 11.5 mm. The number of windings in the Rx coil 214 may be, by way of example only, approximately 130 windings. The transmitting coil (e.g., Tx coil 212) may include a conductive wire having a wire diameter of about 1.7 mm. The wire may be a multi-strand wire. The transmitting coil in this example may have a diameter of about 14.5 mm and a length of about 67 mm. The Tx coil 212 may include a ferrite rod having a diameter of about 8 mm and a length of about 68 mm. Approximately 74 windings may be used for the transmitting coil. Other combinations may be used for the transmitting and receiving coils, in other examples, e.g., to optimize power transfer efficiency even at distances in excess of approximately 30 cm or more. In some examples, the transfer distance may exceed 12 inches. In some examples herein, the transmitting and receiving coils may not be impedance matched, as may be typical in conventional wireless power transfer systems. Thus, in some examples, the transmitting and receiving coils of the wireless power transmitter and wireless power receiver, respectively, may be referred to as being loosely-coupled. According to some examples, the wireless power transmitter is configured for low Q factor wireless power transfer. For example, the wireless power transmitter may be configured for wireless power transfer at Q factors less than 500 in some examples, less than 250 in some examples, less than 100 in some examples, less than 80 in some examples, less than 60 in some examples, and other Q factors may be used. While impedance matching is not required, the coils may be, for example, at least partially impedance matched. In other words, while the transmitting and receiving coils in wireless powers transfer systems described herein may be typically loosely coupled, the transmitting and receiving coils may be impedance matched.

The receiving coil (e.g., Rx coil 214) may include conductive windings, for example copper windings. Conductive materials other than copper may be used. In some examples, the windings may include monolithic (e.g., single-strand) or multi-strand wire. In some examples, the core may be a magnetic core which includes a magnetic material such as ferrite. The core may be shaped in the form of a rod. The receiving coil may have a dimension that is smaller than a dimension of the transmitting coil, for example a diameter, a length, a surface area, and/or a mass of the core (e.g., rod) may be smaller than a diameter, a length, a surface area, and/or a mass of the core (e.g., rod) of the transmitting coil. In some examples, the magnetic core (e.g., ferrite rod) of the transmitting coil may have a surface area that is two greater or more than a surface area of the magnetic core (e.g., ferrite rod) of the receiving coil. In some examples, the transmitting coil may include a larger number of windings and/or a greater length of wire in the windings when unwound than the number or length of wire of the windings of the receiving coil, In some examples, the length of unwound wire of the transmitting coil may be at least two times the length of unwound wire of the receiving coil.

In some examples, an Rx coil 214 may have a length from about 10 mm to about 90mm and a radius from about 1 mm to about 15 mm. In one example, the Rx coil 214 may have a ferrite rod 20 mm in length and 2.5 mm in diameter with 150 conductive windings wound thereupon; and a Tx coil 212 may be configured to broadcast power at frequency of about 125 KHz. The Tx coil 212 may include a ferrite rod having a length of approximately 67.5 mm and a diameter of approximately 12 mm. The transmitting and receiving coils may be arranged in a variety of orientations including a coaxial and a parallel orientation in which the axes of the coils were parallel to one another.

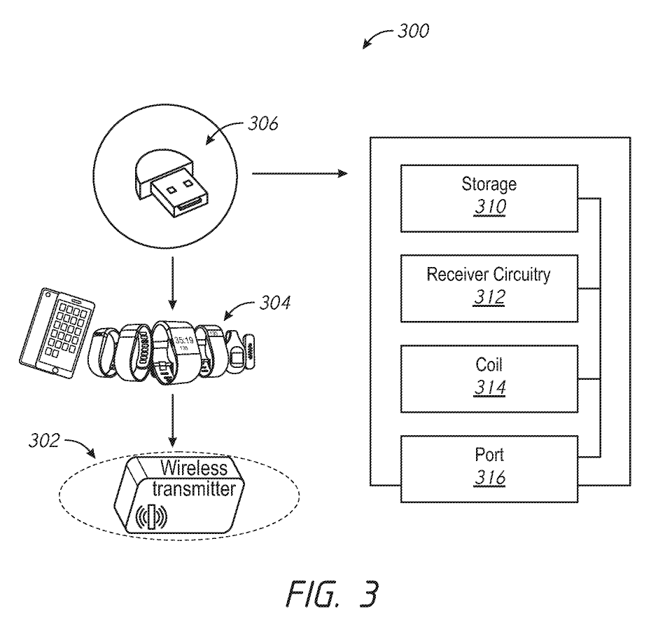

FIG. 3 a wireless power system 300 arranged in accordance with examples described herein.

The wireless power system 300 includes a wireless power transmitting device 302 (e.g., wireless power transmitter), electronic devices 304, and a wireless power receiver 306. The wireless power transmitting device 302, the electronic device 304, the wireless power receiving device 306 may be, for example, implemented using wireless power transmitting device 102, one or each of the plurality of electronic devices 104, and the wireless power receiver 106, respectively (referring to FIG. 1).

The wireless power receiver 306 may include storage 310, receiver circuitry 312, coil 314, and a port 316 (e.g., a universal serial bus (USB) port). The storage 310 and the coil 314 may be implemented using, for example, the power supply 110 and the RX coil 114, respectively (referring to FIG. 1). The wireless power transmitting device 302 may include a coil and electronic circuitry.

The coil 314 of the wireless power receiver 306 may during operation be wirelessly coupled to the coil of the wireless power transmitting device 302. The wireless power receiver 306 may use the coil 314 to wirelessly receive power from the wireless power transmitting device 302. The wireless power receiver 306 may be separated from the wireless power transmitting device 302 by a distance. The wireless power receiver 306 may be coupled (e.g., inserted or attached) via the port 316 to the electronic device 304 by using the port of the electronic device 304. The coil 314 of the wireless power receiver 306 may be coupled via the receiver circuitry 312 to the port 316 of the wireless power receiver 306. In some examples, the receiver circuitry 312 may include one or more converters (e.g., USB converters). The receiver circuitry 312 and coil 314 of the wireless power receiver 306 may provide power through the port 316 to a mated port of the electronic device 304 to power the electronic device 304. The wireless power receiver 306 may be coupled to the electronic device 304 while remaining wirelessly coupled to the wireless power transmitting device 302. The wireless power receiving device 306 may communicate with the wireless power transmitting device 302 by using a frequency or range of frequencies.

The wireless power receiver 306 may be implemented using any of various types of ports for the port 316. For example, the wireless power receiver 306 may include a female USB port separate from and removeably coupleable to the port of the electronic device 304 (e.g., a male USB port). Alternatively, the wireless power receiver 306 may include a male USB port separate from and removeably coupleable to the port of the electronic device 304 (e.g., a female USB port). The wireless power receiver 306 may be coupled to the electronic device 304 by using, for example, a Type-A USB port, a Type-C USB port, a Micro USB port, and/or a Thunderbolt port. Other types of ports may be used in other examples.

The wireless power receiver 306 may wirelessly communicate data signals to and from the wireless power transmitting device 302. For example, the data signals may be wirelessly transmitted to, and received from, the wireless power transmitting device 302 at the same time (e.g., simultaneously) as when power is wirelessly received by the wireless power receiver 306 from the wireless power transmitting device 302. The wireless power receiver 306 may use the port of the wireless power receiver 306 to provide power and data signals to and from the electronic device 304 via the port of the electronic device 304.

The wireless power receiver 306 may automatically receive power from the wireless power transmitting device 302 when the wireless power receiver 306 is within proximity of the wireless power transmitting device 302 (e.g., when the wireless power receiver 306 is within a predetermined distance, or within a charging range, from the wireless power transmitting device 302). The coil 314 (e.g., an Rx coil) in the wireless power receiver 306 may be inductively coupled to the coil (e.g., Tx coil) of the wireless power transmitting device 302. The coil 314 of the wireless power receiver 306 may be loosely coupled to the coil of the wireless power transmitting device 302. The wireless power receiver 306 may be mobile or stationary. The coil 314 of the wireless power receiver 306 may include a ferrite core. The ferrite core of the coil 314 may be rod shaped. The wireless power receiver 306 may provide power received from the wireless power transmitting device 302 to the storage 310 (e.g., battery).

In some examples, the wireless power receiver 306 may additionally be able to be disposed in a plug-in smart case that is pluggable in to an AC outlet or other power source to charge an internal storage (e.g., storage 135). In some examples, the wireless power receiver 306 may be implemented in the form of a dongle adapter pluggable into any of the electronic devices 304 via a USB port (e.g., Type-A, Type-C, Micro, Thunderbolt) of the electronic devices 304. For any electronic device 304 able to receive power from the USB port, the electronic device 304 may receive power from the wireless power receiver 306 via the USB port. In some examples, the wireless transmitter 302 may be able to be disposed in a plug-in smart case that may be pluggable in to an AC outlet or other power source to charge storage internal to the wireless transmitter 302.

In some examples, the electronic device 304 includes a port configured for receipt of electric power, a controller, storage (e.g., battery), and an electrical circuit coupling the port to the storage. The electronic device 304 to which the wireless power receiver 306 is coupled may be placed near to, next to, or on top of a smart case including the wireless power transmitting device 302. For example, wireless power receiver 306 coupled to the USB Rx adapter may be within an 11 inch radius of the wireless power transmitting device 302 in some examples to ensure the most efficient power transfer from the wireless power transmitting device 302. Other distances may be used in other examples. The wireless power transmitting device 302 may then recharge or power some or all of the electronic devices 304 wirelessly through the respective wireless power receivers coupled to (e.g., inserted in) power-conveying ports of the electronic devices.

in some examples, a software application may be provided for controlling the wireless transmitter 302 and/or the charging system 300. The software application (e.g., computer readable media encoded with executable instructions for controlling the wireless transmitter 302 and/or the charging system 300) may be running by one or more processing units (e.g., processors) on the wireless transmitter 302, electronic device 304, and/or another device in communication with the wireless transmitter 302 (e.g., a mobile phone). In some examples, the wireless transmitter 302 may transmit power and/or data to the device running the software application. The device running the software application and/or another device in communication with that device may display which electronic devices 304 are wirelessly connected to the wireless transmitter 302 and may add, configure, and delete one or more of the electronic devices 304 from wireless power transfer with the wireless power transmitting device 302. The software application may have a user-customized ability to target which devices are charging via wireless power transfer with the wireless power transmitting device 302. The software application may cause display of a percentage of battery power for each of the connected electronic devices 304. The software application may provide synching capabilities including a default automatic sync (e.g., 24-hour sync, or other periodic sync) with the wireless power transmitting device 302.

The wireless power transmitting device 302 may be mobile. The coil of the wireless power transmitting device 302 and the coil 314 of the wireless power receiver 306 may have the same or substantially the same coil ratios. Alternatively, a length of a coil of the wireless power transmitting device 302 may be 2× or greater than a length of the coil 314 of the wireless power receiver 306. The coil of the wireless power transmitting device 302 may be loosely coupled to the coil 314 of the wireless power receiver 306. The ferrite core of the coil of the wireless power transmitting device 302 may be rod shaped. The wireless power transmitting device 302 may communicate data signals to and from the electronic device 304 using any of a variety of forms of wireless communication, The wireless power transmitting device. 302 of the wireless power system 300 may have a Q value of 100 or less.

The electronic device 304 may use the wireless power receiver 306 to perform wireless power charging of the storage (e.g., battery) of the electronic device 304. The electronic device 304 may be separated from the wireless power transmitting device 302 by a distance. The electronic device 304 may be capable of being attached to the wireless power receiver 306 by using, for example, the USB port (e.g., Type-A USB port, Type-C USB port Micro USB port, or Thunderbolt port). The electronic device 304 may be an electronic device incapable of receiving wireless power sufficient for normal operation without wirelessly receiving power via the wireless power receiving device 306. The electronic device 304 incapable of wireless power sufficient for normal operation may be converted to an electronic device capable of wireless power charging by using the wireless power receiver 306 (e.g., by coupling the wireless power receiver 306 to a port of the electronic device 304).

In some examples, the electronic device 304 may not include a battery and may instead be directly powered by wireless power provided by the wireless power transmitting device 302 via the wireless power receiver 306. In some examples, the electronic device 304 may include a capacitor (e.g., supercapacitor or ultracapacitor) operatively coupled to the coil 314 of the wireless power receiving device 306 via the port 316 coupled to the port of the electronic device 304.

The electronic devices 304 may be implemented using any of a variety of electronic devices, for example and without limitation, an electronic device worn on the body such as around the wrist (e.g., an electronic watch or a biometric device, such as a pedometer), a UV/HEV sensor, a pedometer, a night light, a blue tooth enabled communication device (e.g., a blue tooth headset, a hearing aid or an audio system), a camera, image capture device, IR camera, still camera, video camera, image sensor, repeater, resonator, sensor, sound amplifier, directional microphone, eyewear supporting an electronic component, spectrometer, directional microphone, microphone, camera system, infrared vision system, night vision aid, night light, illumination system, sensor, pedometer, wireless cell phone, mobile phone, wireless communication system, projector, laser, holographic device, holographic system, display, radio, GPS, data storage, memory storage, power source, speaker, fall detector, alertness monitor, geo-location, pulse detection, gaming, eye tracking, pupil monitoring, alarm, CO sensor, CO detector, CO2 sensor, CO2 detector, air particulate sensor, air particulate meter, UV sensor, UV meter, IR sensor, IR meter, thermal sensor, thermal meter, poor air sensor, poor air monitor, bad breath sensor, bad breath monitor, alcohol sensor, alcohol monitor, motion sensor, motion monitor, thermometer, smoke sensor, smoke detector, pill reminder, audio playback device, audio recorder, speaker, acoustic amplification device, acoustic canceling device, hearing aid, assisted hearing assisted device, informational earbuds, smart earbuds, smart ear-wearables, video playback device, video recorder device, image sensor, fall detector, alertness sensor, alertness monitor, information alert monitor, health sensor, health monitor, fitness sensor, fitness monitor, physiology sensor, physiology monitor, mood sensor, mood monitor, stress monitor, pedometer, motion detector, geolocation, pulse detection, wireless communication device, gaming device, eyewear comprising an electronic component, augmented reality system, virtual reality system, eye tracking device, pupil sensor, pupil monitor, automated reminder, light, alarm, cell phone device, phone, mobile communication device, poor air quality alert device, sleep detector, doziness detector, alcohol detector, thermometer, refractive error measurement device, wave front measurement device, aberrometer, GPS system, smoke detector, pill reminder, speaker, kinetic energy source, microphone, projector, virtual keyboard, face recognition device, voice recognition device, sound recognition system, radioactive detector, radiation detector, radon detector, moisture detector, humidity detector, atmospheric pressure indicator, loudness indicator, noise indicator, acoustic sensor, range finder, laser system, topography sensor, motor, micro motor, nano motor, switch, battery, dynamo, thermal power source, fuel cell, solar cell, kinetic energy source, thermo electric power source, and a smart device (e.g., smart band, smart watch, smart earring, smart necklace, smart clothing, smart belt, smart ring, smart bra, smart shoes, smart footwear, smart gloves, smart hat, smart headwear, smart eyewear).

The wireless power receiver that may be coupled to the electronic device may allow a user of a consumer electronics device to enjoy the benefits of wireless power without the need to replace batteries or plug-in the device. The wireless power receiver may facilitate an internal battery of the electronic device to be recharged wirelessly and automatically during the day and/or at night through a universal wireless micro-sized receiver coil that communicates with a wireless transmitter coil. The wireless power receiver may allow a user of a wireless transmitter to leverage the accessory for wireless powering or charging other consumer electronic devices with a USB port (e.g., USB slot) (e.g., USB Type-A port, Type-C, Micro port, or Thunderbolt port) and not require or lessen the need for a wireless receiver coil embedded into the electronic board or other component of the electronic device itself. The wireless power receiver may allow for the system to maintain and leverage a plurality of existing designs of consumer electronic devices while lessening a need to change the size or makeup of those devices to support wireless power charging.

The wireless power system 300 can be a magnetic resonant system in that magnetic resonance may occur between the wireless transmitter 302 and one or more of the wireless power receivers.

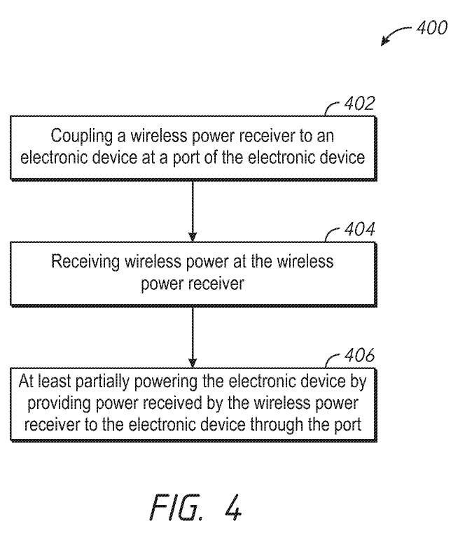

FIG. 4 is a method for operating a wireless power receiving device 400 according to examples described herein.

The method for operating a wireless power receiving device 400 may include coupling a wireless power receiver to an electronic device at a port of the electronic device, as shown in block 402. The method may further include receiving wireless power at the wireless power receiving device, as shown in block 404. The method may further include at least partially powering the electronic device by providing power received by the wireless power receiving device to the electronic device through the port, as shown in block 406.

The method 400 may be implemented using the wireless power system 300 of FIG. 3.

In some examples, coupling a wireless power receiver to an electronic device at a port of the electronic device may include coupling a receiving coil of the wireless power receiver to storage (e.g., battery) of the electronic device. The coupling between the receiving coil of the wireless power receiver and the power supply of the electronic device may be provided by an electrical coupling via a port of the wireless power receiver coupled to a port of the electronic device. The port of the wireless power receiver and the port of the electronic device may be USB ports (e.g., USB connectors).

In some examples, receiving wireless power at the wireless power receiver includes receiving, by the receiving coil, a wireless power signal transmitted by a wireless power transmitter. The wireless power signal may be converted to a power signal capable of being provided to the electronic device by the wireless power receiver. The wireless power signal may be received by the wireless power receiver by using windings and a core of the receiving coil. Power may be transmitted to the wireless power receiver and from the wireless power transmitter based on resonant coupling between the wireless power receiver and the wireless power transmitter.

In some examples, at least partially powering the electronic device by providing power received by the wireless power receiver to the electronic device through the port may include providing a power signal from the wireless power receiver to the electronic device. The power signal may be provided from the coil of the wireless power receiver by using a circuit of the wireless power receiver to the power supply of the electronic device by using the circuit of the electronic device. The power signal may be provided through the port of the wireless power receiver to the port of the electronic device. The power signal provided to the electronic device may be used for various purposes including, for example, powering the electronic device and/or charging storage of the electronic device.

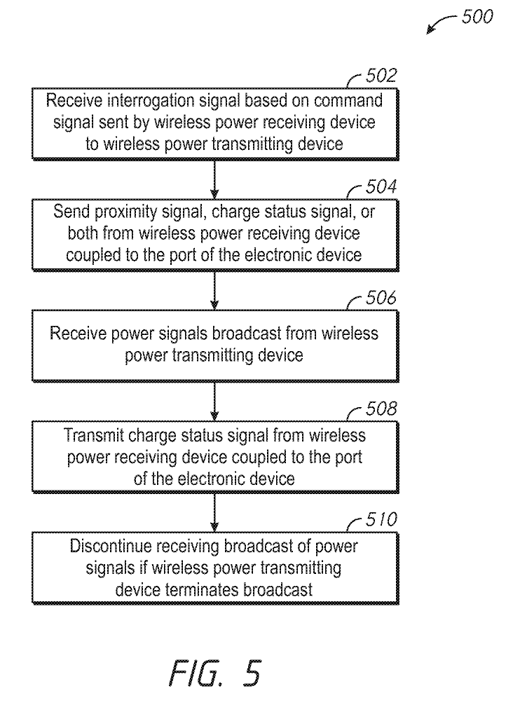

FIG. 5 is a method for operating a wireless power receiving device 400 according to examples described herein.

in the example of FIG. 5, a wireless power transmitting device is communicatively coupled to a wireless power receiver such that the wireless power receiver may transmit a command signal to the wireless power transmitting device. The command signal may be a command to initiate broadcast of interrogation signals, as shown in block 502. The wireless power transmitting device may transmit an interrogation signal responsive to the command signal. Proximity and/or charge status signals may be transmitted from one or more wireless power receiving devices in respective electronic devices in proximity. Upon detection of a wireless power receiver in proximity, the wireless power receiver may receive broadcast power signals transmitted by the wireless power transmitting device automatically controlled by the controller (block 506). In some examples, an indication of a detected electronic device may be displayed on a display in communication with the wireless transmitter and/or receiver. The wireless power transmitting device may transmit a command signal under the direction of a user, which may be a command to initiate power transfer. The wireless power transmitting device may continue to monitor the charge status of the electronic device (e.g., via broadcast of interrogation signals and receipt of responsive charge status signals from the electronic device), as shown in block 508. Broadcast of power from the wireless power transmitting device may be terminated upon the occurrence of an event, as shown in block 510. The event may correspond to receiving an indication of fully charged status from the one or more electronic devices being charged, receiving an indication of depleted stored power in the power supply of the wireless power transmitting device, or a determination that no electronic device remains in proximity to the wireless power transmitting device. In some example, the broadcast of power may continue but at a reduced power level upon a determination that the wireless power transmitting device is in motion (e.g., being carried or moved by a user).

Examples described herein may provide a low cost, small form factor, light weight and portable wireless power receiver that can wirelessly receive power from a wireless power transmitting device. Upon or after receiving power from an external source, the wireless power receiver can be used for powering electronic devices with wireless power to either charge storage (e.g., a battery or capacitor) of the electronic device or to power operations of the electronic device. The electronic device can be implemented using, by way of example only, a watch, band, necklace, earring, ring, head wear, hearing aid, hearing aid case, hearing aid control unit, eyewear, augment reality unit, virtual reality unit, implant, clothing article, wearable article, implanted device, cell phone. Wireless power transmitting devices described herein may include a transmitter, an external power port and associated electronics. The transmitter can include a metal winding, by way of example only copper wire, around a. magnetic material core. The transmitter core can include, by way of example only, iron, ferrites, iron alloys, a mu metal, Vitroperm 500F, and/or a high permeability metal. The transmitter can include a ferrite core. The winding can be of a copper wire. The winding can be of Litz wire. The external power port can be a USB port. The USB port can be electrically connected to a lap top, desk top, cell phone, smart pad, communication system, Mophie Case, rechargeable cell phone case, or other source of power. In this manner, the wireless power receiver may be formed as a “dongle” or other accessory device having a USB or other electronic interface to an electronic device and a coil for coupling to a wireless transmitter. The transmitter can be wireless coupled to a distance separated receiver of an electronic device. The electronic device can be an electronic wearable device. Example wireless power transmitting devices may include at least one USB converter, an RF source for generation a time varying signal, said signal being provided to an RF antenna or a magnetic coil. Example wireless power transmitting devices may include a ferrite core and copper wire windings.

Examples wireless power transmitting devices may accordingly be powered by a third party power source. Such a third party power source can be, by way of example only, that of a computer, laptop, cell phone, smart pad, an electrical power socket, or combinations thereof.

Some example wireless power transmitting devices may include a battery, which in some examples may be a very small form factor battery, or capacitor should one be desirable for minimal power source to keep electronics functional if power from the source were to fluctuate or otherwise be momentarily unavailable. In some examples a wireless power transmitting device may serve as a portable wireless charging unit.

From the foregoing it will be appreciated that, although specific embodiments have been described herein for purposes of illustration, various modifications may be made while remaining with the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signal may be provided directly to and/or received directly from the recited components without intervening components, but also may be provided to and/or received from the certain components through intervening components.

What is claimed is:

1. A wireless power conversion system comprising:
a wireless power receiver including a coil for receipt of wireless power from a. distance separated wireless power transmitter; and
an electronic device including a port configured for receipt of electrical power to at least partially power the electronic device, wherein the wireless power receiver is removably coupleable to the port and configured to at least partially power the electronic device through the port by providing power received by the wireless power receiver.

2. The wireless power conversion system of claim rein the port comprises a universal serial bus (USB) port.

3. The wireless power conversion system of claim 1, wherein the electronic device has insufficient power to operate without use of the power received by the wireless power receiver, and wherein the electronic device is incapable of receiving wireless power without being coupled to the wireless power receiver.

4. The wireless power conversion system of claim 1, wherein the wireless power receiver comprises a ferrite core.

5. The wireless power conversion system of claim 4, wherein the ferrite core of the wireless receiver is rod shaped.

6. The wireless power conversion system of claim 1, further comprising the wireless power transmitter, and wherein the wireless power transmitter comprises a ferrite core.

7. The wireless power conversion system of claim 5, wherein the ferrite core of the wireless transmitter is rod shaped.

8. The wireless power conversion system of claim 1, wherein the wireless power receiver is configured to be in weak resonance coupling with the wireless power transmitter.

9. The wireless power conversion system of claim 1, wherein the universal wireless power system comprises a magnetic resonant system.

10. The wireless power conversion system of claim 1 wherein the range of RF wavelengths is selected to be no more than ten times a longest dimension of a receiving antenna.

11. The wireless power conversion system of claim 1 wherein the receiver comprises a temperature controller.

12. The wireless power conversion system of claim 6, wherein the wireless power transmitter is further configured to wirelessly transmit data to, and wirelessly receive data from, the wireless power receiver, and wherein the electronic device is configured to provide data to, and receive data from, the wireless power receiver through the port.

13. The wireless power conversion system of claim 6, wherein the wireless power transmitter is mobile.

14. The wireless power conversion system of claim 1, wherein the wireless power receiver is mobile.

15. The wireless power conversion system of claim 6, wherein a length of a coil of the wireless power transmitter is at least twice as long a length of a coil of the wireless power receiver.

16. The wireless power conversion system of claim 1, wherein the port of the electronic device is a universal serial bus (USB) port, and wherein the wireless power receiver includes a female USB connector separate from and removably coupled to the port.

17. The wireless power conversion system of claim 1, wherein the port comprises a universal serial bus (USB) port, and wherein the wireless power receiver includes a male USB connector for connection to the port of the electronic device.

18. The wireless power conversion system of claim 1, wherein the port comprises a universal serial bus (USB) port, and wherein the wireless power receiver comprises a female USB connector for connection to the port of the electronic device.

19. The wireless power conversion system of claim 1, wherein the wireless power receiver further comprises a circuit.

20. The wireless power conversion system of claim 19, wherein said circuit comprises adjustable inductance, capacitance, resistance, or combinations thereof, and wherein said inductance, capacitance, resistance, or combinations thereof are automatically adjusted to maintain resonant coupling between the circuit and another circuit of a wireless power transmitter.

21. The wireless power conversion system of claim 1, wherein the universal wireless power system has a Q value of 100 or less.

22. A method comprising:
coupling a wireless power receiver to an electronic device at a port of the electronic device;
receiving wireless power at the wireless power receiver; and
at least partially powering the electronic device by providing power received by the wireless power receiver to the electronic device through the port.

23. The method of claim 22, wherein the port comprises a USB port.
